(19) United States
(12) Patent Application Publication
(10) Pub. No.: US 2008/0130462 A1
(43) Pub. Date: Jun. 5, 2008

(54) Optical Device, in Particular Holographic Device

(75) Inventors: Frank Jeroen Pieter Schuurmans, Eindhoven (NL); Gert 'T Hooft, Eindhoven (NL); Marcello Leonardo Mario Balistreri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,006

(22) PCT Filed: Jan. 6, 2006
(86) PCT No.: PCT/IB06/50058

§ 371 Date: Jul. 16, 2007

(30) Foreign Application Priority Data
Jan. 17, 2005 (EP) 05300039.4

(51) Int. Cl. G11B 7/0065

(52) U.S. Cl. 369/103

(57) ABSTRACT

An optical device comprises a light source (301) for generating a radiation beam, a reflective diffractive structure (304) for reflecting and diffracting said radiation beam along an optical path (PP), imaging means (305) for imaging the radiation beam after it has been reflected and diffracted by said reflective diffractive structure, and a holographic beam splitter (303) between said reflective diffractive structure and said imaging means along said optical path. Such an optical device can be used for recording data into a holographic medium.

### FIELD OF THE INVENTION

The present invention relates to an optical device. It particularly relates to an optical holographic device for recording in and/or reading out a data page from a holographic medium.

The invention also relates to a method for manufacturing such an optical device, and to a holographic beam splitter.

### BACKGROUND OF THE INVENTION

Many optical devices use a reflective diffractive structure. An example of such an optical device is a device using a Digital Mirror Device (DMD). Another example is a holographic device using a reflective Spatial Light Modulator (SLM). Such an optical device is described in Lambertus Hesselink, Sergei S. Orlov and Matthew C. Bashaw, “Holographic data storage systems”, in “Proceedings of the IEEE”, Vol. 92, no 8, August 2004, page 1262. Such a holographic device is depicted in FIG. 1. It comprises a radiation source 101 for generating a radiation beam, a collimator 102, a polarizing beam splitter (PBS) 103, a reflective spatial light modulator (SLM) 104, a first imaging lens 105, a second imaging lens 107 and a detector 108. This holographic device is intended to record data in and read data from a holographic medium 106. The radiation beam generated by the radiation source 101 is directed towards the reflective SLM 104 by means of the PBS 103. The radiation beam is diffracted and reflected by the reflective SLM 104, and a signal beam is thus created, which comprises a data page encoded in the reflective SLM 104. The signal beam is spatially modulated by means of the reflective SLM 104. The reflective SLM 104 comprises reflective areas and absorbent areas, which correspond to zero and one data-bits of a data page to be recorded. The signal beam carries the signal to be recorded in the holographic medium 106, i.e. the data page to be recorded.

This signal beam is imaged on the holographic medium 106 by means of the first imaging lens 105. The signal beam interferes with a reference beam (not shown) inside the holographic medium 106, and a data pattern is thus created. Another data page may be recorded at the same place in the holographic medium 106, for example in that the wavelength of the radiation source is tuned. This is called wavelength multiplexing. Other kinds of multiplexing, such as angle multiplexing, shift multiplexing or phase-encoded multiplexing, may also be used for recording data pages in the holographic medium 106.

During read-out of the data page recorded in the holographic medium 106, the reference beam (not shown) is sent towards the holographic medium 106, and is diffracted by the data pattern recorded in the holographic medium 106. The diffracted beam is then imaged on the detector 108 by means of the second imaging lens 107. The detector 108 comprises pixels or detector elements, each detector element corresponding to a bit of the imaged data page.

This holographic device has a so-called 4f configuration, which means that the first and second imaging lenses 105 and 107 have a focal distance f, the distance between the SLM 104 and the first imaging lens 105 is f, the distance between the first imaging lens 105 and the holographic medium 106 is f, the distance between the holographic medium 106 and the second imaging lens 107 is f and the distance between the second imaging lens 107 and the detector 108 is f. The density of data recorded in the holographic medium 106 depends on the numerical aperture NA of the first imaging lens 105. The larger the numerical aperture NA, the higher the data density. Now, the numerical aperture NA is limited in this holographic device, because the numerical aperture NA is inversely proportional to the focal distance f of the first imaging lens 105, which has to be larger than the size of the PBS 103. The PBS 103 in this optical device is relatively large, because the partially reflective surface of the PBS 103 has to be oriented 45 degrees from the direction of the radiation beam generated by the radiation source 101. As a consequence, the data density is limited.

### SUMMARY OF THE INVENTION

It is an object of the invention to provide an optical device of the type described in the prior art in which the numerical aperture of the first imaging lens is increased, in particular a holographic device in which the data density is increased.

To this end, the invention proposes an optical device comprising a light source for generating a radiation beam, a reflective diffractive structure for reflecting and diffracting said radiation beam along an optical path, imaging means for imaging the radiation beam after it has been reflected and diffracted by said reflective diffractive structure, and a holographic beam splitter between said reflective diffractive structure and said imaging means along said optical path. According to the invention, the PBS 103 is replaced by a holographic beam splitter. As explained in detail in the following description, the size of a holographic beam splitter can be reduced with respect to the size of a conventional PBS. As a consequence, the distance between the reflective diffractive structure and the imaging means can be reduced, which allows increasing the numerical aperture of the imaging means. In case of a holographic device, this allows increasing the data density recorded in a holographic medium.

Advantageously, the holographic beam splitter comprises a holographic material with a thickness L, and the reflective diffractive structure has a mean diffraction step d, wherein d<L. Advantageously, L/d>50. This reduces the amount of radiation that is diffracted back towards the radiation source, and thus increases the amount of radiation that reaches the holographic medium, thus increasing the S/N ratio.

Preferably, the holographic beam splitter is arranged in such a way that a first portion of the radiation beam reflected and diffracted by said reflective diffractive structure is diffracted back towards the radiation source, the optical device comprising means for monitoring a wavelength of said radiation source on the basis of said first portion. This first portion is used as optical feedback for the radiation source. Depending on the intensity of the first portion received by the radiation source, the wavelength of the radiation source can be finely tuned, as explained in details in the following description.

Advantageously, the holographic beam splitter is arranged in such a way that a first portion of the radiation beam generated by the radiation source is transmitted through the holographic beam splitter, the optical device comprising means for monitoring a wavelength of said radiation source on the basis of said first portion. Depending on the intensity of the first portion received by the radiation source, the wavelength of the radiation source can be finely tuned, as explained in details in the following description.

Preferably, the holographic beam splitter comprises holographic patterns that have been recorded at different wavelengths. This allows wavelength multiplexing.

The invention also relates to a holographic beam splitter comprising holographic patterns that have been recorded at different wavelengths.

The invention also relates to a method for manufacturing an optical device, said method comprising the steps of providing a light source for generating a radiation beam, providing a reflective diffractive structure for reflecting and diffracting said radiation beam along an optical path, providing imaging means for imaging the radiation beam after it has been reflected and diffracted by said reflective diffractive structure, and providing a holographic beam splitter between said reflective diffractive structure and said imaging means along said optical path.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows an optical device in accordance with the prior art;

FIGS. 2a to 2d show how a holographic beam splitter is manufactured;

FIG. 3 shows an optical device in accordance with the invention;

FIG. 4a shows the intensity of the radiation beam reflected and diffracted by the refractive diffractive structure of FIG. 3 and FIG. 4b shows the intensity of the radiation beam imaged on the holographic medium of FIG. 3.

### DETAILED DESCRIPTION OF THE INVENTION

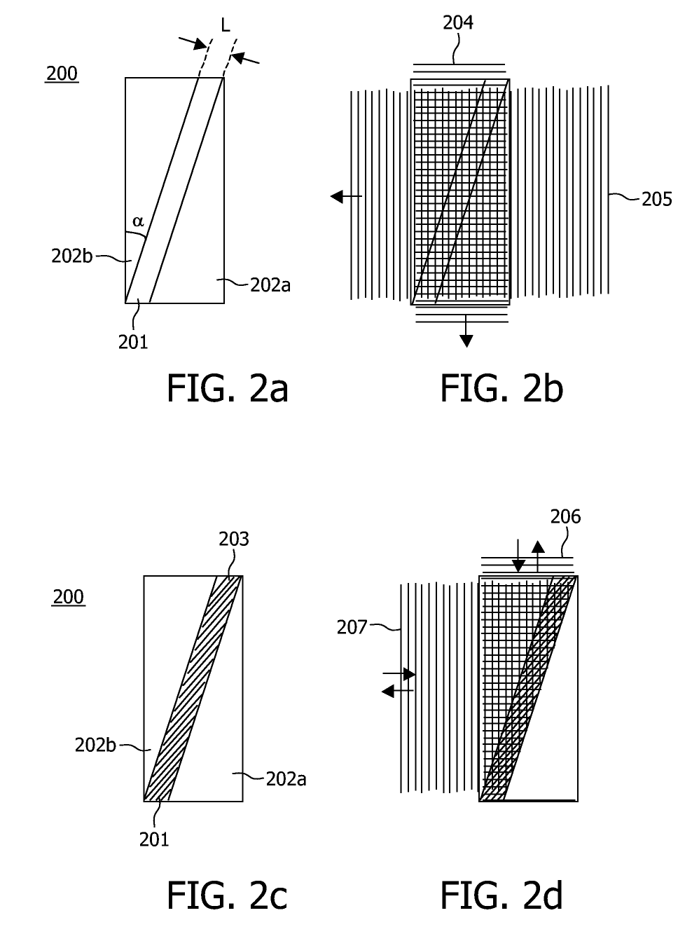

FIG. 2c shows a holographic beam splitter 200 used in an optical device in accordance with the invention. The holographic beam splitter 200 comprises two glass wedges 202a and 202b between which a holographic material 201 is applied. The thickness of the holographic material 201 is L. The holographic material 201 preferably has the same refractive index as the glass wedges 202a and 202b. A holographic pattern 203 is recorded in the holographic beam splitter 200, as depicted in FIGS. 2a and 2b.

FIG. 2a shows the holographic beam splitter 200 before a holographic pattern 203 is recorded. The holographic beam splitter 200 comprises the two glass wedges 202a and 202b between which the holographic material 201 is applied. In order to record the holographic pattern 203, a first plane wave 204 and a second plane wave 205 are directed towards the holographic beam splitter 200. The first plane wave 204 and the second plane wave 205 are perpendicular to each other. The holographic pattern 203 is generated inside the holographic material 201 by interference of the first and second plane waves 204 and 205, in the form of refractive index modulation.

FIG. 2d shows how the holographic beam splitter 200 is used. When a third wave plane 206, identical to the first wave plane 204, is directed towards the holographic beam splitter 200, it is diffracted by the holographic pattern 203, which creates a fourth wave plane 207, similar to the second wave plane 205. In this example, 100 percent of the third wave plane 206 is diffracted. However, the holographic beam splitter 200 can be designed in such a way that a first portion of the third wave plane 206 is transmitted through the holographic beam splitter 200 without being diffracted. The example shown in FIGS. 2a to 2d is only one instance of many possible methods of manufacturing such a holographic beam splitter 200. Detailed information about holographic beam splitters can be found in “Principles and Spectroscopic Applications of Volume Holographic Optics”, Analytical Chemistry, Vol. 65, No. 9, May 1, 1993, pages 441A-449A. It should be noted that the holographic beam splitter 200 behaves symmetrically, i.e. when a fifth wave plane parallel to the fourth wave plane 207 is sent towards the holographic beam splitter 200, it is diffracted in a direction parallel to the third wave plane 206.

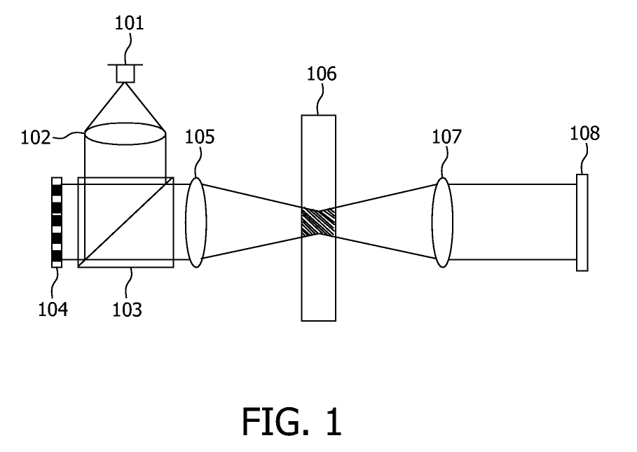

Due to the way the holographic beam splitter 200 is designed, the holographic material 201 can be oriented with an angle α that is inferior to 45 degrees. Actually, the deviation of the third plane wave 206 is based on diffraction, and not on reflection, as would be the case with a conventional PBS such as the PBS 103 of FIG. 1. The angle α can be chosen as small as a few degrees, for example the angle α can be inferior to 10 degrees. As a consequence, the width of the holographic beam splitter 200 is relatively low, compared to the width of a conventional PBS such as the PBS 103 of FIG. 1, which is a cubic beam splitter.

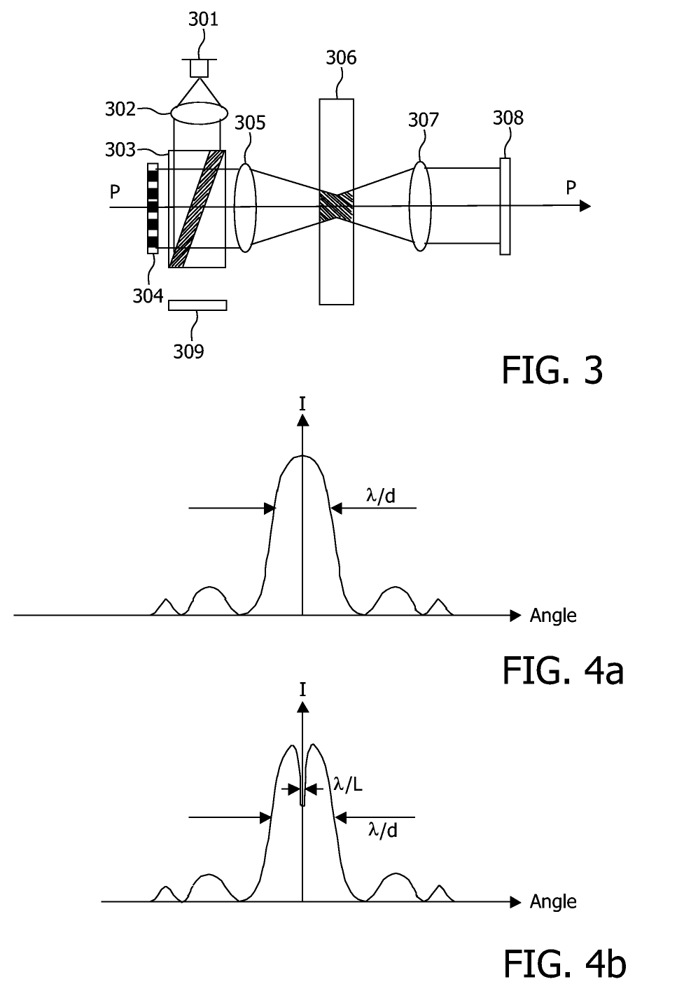

An optical device in accordance with the invention is depicted in FIG. 3. It comprises a radiation source 301 for generating a radiation beam, a collimator 302, a holographic beam splitter 303, a reflective spatial light modulator (SLM) 304, a first imaging lens 305, a second imaging lens 307 and a detector 308. This optical device is intended to record data in and read data from a holographic medium 306. As explained in FIGS. 2a to 2d, the width of the holographic beam splitter 303 is lower than the width of the PBS 103 of FIG. 1. As a consequence, the focal distance of the first imaging lens 305 can be reduced with respect to the focal distance of the first imaging lens 105 of FIG. 1. The numerical aperture of the first imaging lens 305 is thus increased and the data density that can be recorded in the holographic medium 306 is increased.

The radiation beam generated by the radiation source 301 is collimated by the collimator 302, and then reaches the holographic beam splitter 303. In the following example, the holographic beam splitter 303 is designed in such a way that 100 percent of the radiation beam that reaches the holographic beam splitter 303 is diffracted towards the reflective SLM 304, along an optical path PP. The radiation beam that reaches the reflective SLM 304 is reflected by said reflective SLM 304 towards the holographic beam splitter 303 along the optical path PP. Moreover, as the reflective SLM 304 comprises reflective and absorbent areas, which corresponds to zero and one data-bits of a data page to be recorded, this reflective SLM 304 acts as a diffractive structure. For each area of the reflective SLM 304, a diffracted sub-radiation beam is generated and reflected towards the holographic beam splitter 303 along the optical path PP. The diffracted and reflected sub-radiation beams form the diffracted and reflected radiation beam.

FIG. 4a shows the intensity of a diffracted sub-radiation beam, as a function of the angle, the angle 0 corresponding to the direction along the optical path PP. As can be seen from FIG. 4a, the intensity is maximal along the optical path PP, but a large portion of the diffracted sub-radiation beam is diffracted in a direction different from the direction of the optical path PP. The angular spread is roughly equal to λ/d, where λ is the wavelength of the radiation source and d is the mean diffraction step of the diffractive and reflective structure 304. In the example of FIG. 3, the mean diffraction step d of the reflective SLM 304 is equal to the size of one individual area (pixel) of the reflective SLM 304, which is typically a few microns. If all the diffracted and reflected sub-radiation beams were directed along the optical path PP, the diffracted and reflected radiation beam would then be diffracted towards the radiation source 301 by the holographic beam splitter 303, because in this case both the wavelength and the direction of the diffracted and reflected radiation beam would match the so-called Bragg condition. The Bragg condition is the condition of wavelength and direction for which the holographic beam splitter 303 has been designed. In this case, the holographic beam splitter 303 has been designed in such a way that a radiation beam having the wavelength and direction of the fifth wave plane of FIG. 2d is diffracted in a direction parallel to the third wave plane 206 of FIG. 2d.

The angular range around the Bragg matching condition, i.e. the angular range for which a reflected and diffracted sub-radiation beam is diffracted by the holographic beam splitter 303 towards the radiation source 301 is approximately λ/L. Outside this range, the reflected and diffracted sub-radiation is transmitted through the holographic beam splitter 303 towards the first imaging lens 305. FIG. 4b shows the intensity of a diffracted and reflected sub-radiation beam as a function of the angle, after the diffracted and reflected sub-radiation beam has passed through the holographic beam splitter 303. In the example of FIG. 4b, L is superior to d, which can easily be performed. Typically, L is around 1 millimeter such that it is greater than d. As can be seen from FIG. 4b, only a small portion, in the range of angle λ/L, is diffracted towards the radiation source 301, the other portions of the reflected and diffracted sub-radiation beam being transmitted through the holographic beam splitter 303. The portion of the reflected and diffracted sub-radiation beam being diffracted towards the radiation source 301 depends on the ratio L/d. In the example of FIG. 3, it is desired that a large portion of the diffracted and reflected radiation beam is transmitted through the holographic beam splitter 303. This can be achieved in that the ratio L/d is chosen superior to 50, which can be easily achieved has the typical value of d is approximately a few microns.

As explained hereinbefore, a first portion of the diffracted and reflected radiation beam is diffracted towards the radiation source 301, whereas a second, higher portion is transmitted through the holographic beam splitter 303 towards the first imaging lens 305. This means that the light path efficiency of the optical device in accordance with the invention is relatively high. Actually, the ratio L/d can be chosen in such a way that the first portion is inferior to 1 percent, which means that the major part of the radiation beam generated by the radiation source 301 is used to record the data page in the holographic medium 306.

Although it is desired that this first portion is as low as possible, this first portion can be used as optical feedback for the radiation source 301. Actually, if the wavelength of the radiation source 301 does not match the Bragg condition, the first portion will be lower that when the wavelength of the radiation source 301 matches the Bragg condition. This variation in the intensity of the first portion can be used in order to finely tune the wavelength of the radiation source 301 so that it matches the Bragg condition. This can be achieved in that the wavelength of the radiation source 301 is tuned until the intensity of this first portion is maximal. Moreover, a radiation source with optical feedback is less noisy than a conventional radiation source, due to the absence of mode hopping.

In another embodiment, the holographic beam splitter 303 is designed in such a way that less than 100 percent of the radiation beam generated by the radiation source 301 that reaches the holographic beam splitter 303 is diffracted towards the reflective SLM 304, along the optical path PP. This means that a first portion of the radiation beam generated by the radiation source 301 is transmitted through the holographic beam splitter 303. This first portion is detected by a detecting module 309. If the wavelength of the radiation source 301 does not match the Bragg condition, the first portion will be higher that when the wavelength of the radiation source 301 matches the Bragg condition. This variation in the intensity of the first portion is used in order to finely tune the wavelength of the radiation source 301 until the intensity of this first portion is minimal. The wavelength of the radiation source 301 is thus monitored by means of the detecting module 309.

In the examples described hereinbefore, the optical device operates at single frequency, which is the frequency for which the holographic beam splitter 303 has been designed. However, in order to increase the data density in the holographic medium 306, it is desired that the wavelength of the radiation source 301 can be changed, in order to perform so-called wavelength multiplexing. For example, a first data page is first recorded by means of a radiation beam having a first wavelength λ1, and a second data page is recorded at the same place of the holographic medium 306 by means of a radiation beam having a second wavelength λ2. However, if the holographic beam splitter 303 is designed, for example, for the first wavelength λ1, the radiation beam generated by the radiation source 301 with second wavelength λ2 will be completely transmitted through the holographic beam splitter 303, because it will not match the Bragg condition.

This problem can be solved in that the holographic beam splitter 303 comprises holographic patterns that have been recorded at different wavelengths. In this example, a first holographic pattern is recorded with a plane wave having the first wavelength λ1 and a second holographic pattern is recorded with a plane wave having the second wavelength λ2. The radiation beam having the first wavelength λ1 is diffracted by the first holographic pattern and not by the second holographic pattern. The radiation beam having the second wavelength λ2 is diffracted by the second holographic pattern and not by the first holographic pattern. Such a holographic beam splitter with holographic patterns recorded at different wavelengths can easily be manufactured according to the method described in FIGS. 2a to 2c. Once a first holographic pattern has been recorded as described in the description of FIGS. 2a to 2c, with first and second plane waves 204 and 205 having a wavelength λ1, the wavelength of the first and second plane waves 204 and 205 of FIG. 2b is changed to λ2 and the second holographic pattern is recorded.

In the examples described hereinbefore, the surfaces of the holographic beam splitter 303 are flat. However, these surfaces could be curved, without departing from the scope of the invention. In this case, other optical elements of the optical device in accordance with the invention could be incorporated into the holographic beam splitter 303, such as the first imaging lens 305. This reduces the complexity and bulkiness of the optical device.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical device comprising a light source (301) for generating a radiation beam, a reflective diffractive structure (304) for reflecting and diffracting said radiation beam along an optical path (PP), imaging means (305) for imaging the radiation beam after it has been reflected and diffracted by said reflective diffractive structure, and a holographic beam splitter (303) between said reflective diffractive structure and said imaging means along said optical path.

2. An optical device as claimed in claim 1, wherein said reflective diffractive structure is a reflective spatial light modulator.

3. An optical device as claimed in claim 1, wherein said holographic beam splitter comprises a holographic material with a thickness L, and the reflective diffractive structure has a mean diffraction step d, wherein d<L.

4. An optical device as claimed in claim 3, wherein L/d>50.

5. An optical device as claimed in claim 1, wherein the holographic beam splitter is arranged in such a way that a first portion of the radiation beam reflected and diffracted by said reflective diffractive structure is diffracted back towards the radiation source, the optical device comprising means for monitoring a wavelength of said radiation source on the basis of said first portion.

6. An optical device as claimed in claim 1, wherein the holographic beam splitter is arranged in such a way that a first portion of the radiation beam generated by the radiation source is transmitted through the holographic beam splitter, the optical device comprising means (309) for monitoring a wavelength of said radiation source on the basis of said first portion.

7. An optical device as claimed in claim 1, wherein the holographic beam splitter comprises holographic patterns that have been recorded at different wavelengths.

8. A holographic beam splitter comprising holographic patterns that have been recorded at different wavelengths.

9. A method for manufacturing an optical device, said method comprising the steps of providing a light source for generating a radiation beam, providing a reflective diffractive structure for reflecting and diffracting said radiation beam along an optical path, providing imaging means for imaging the radiation beam after it has been reflected and diffracted by said reflective diffractive structure, and providing a holographic beam splitter between said reflective diffractive structure and said imaging means along said optical path.
